(19) United States
(12) Patent Application Publication
(10) Pub. No.: US 2006/0106172 A1
(43) Pub. Date: May 18, 2006

(54) Pressure polymerisation process

(76) Inventor: Ola Karlsson, (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/542,442

(22) PCT Filed: Feb. 3, 2004
(86) PCT No.: PCT/SE04/00142

§ 371 Date: Oct. 24, 2005

(30) Foreign Application Priority Data
Feb. 12, 2003 (SE) 0300373-8

(51) Int. Cl. C08F 297/02

(52) U.S. Cl. 525/242

(57) ABSTRACT

A pressure polymerization process yielding a copolymer comprising monomer units derived from ethylene and at least one vinyl ester is provided. The polymerization is performed in presence of at least one dendritic polymer, such as a dendritic polyester, polyether, polyesteramide, or polyetheramide.

The present invention refers to a pressure polymerisation process yielding a copolymer comprising monomer units derived from ethylene and at least one vinyl ester. The polymerisation process is performed at elevated pressure in the presence of at least one dendritic polymer. The dendritic polymer is preferably at least one dendritic polyester, polyether, polyesteramide and/or polyetheramide.

Ethylene-vinyl ester copolymers are typically prepared in the same manner as polyethylene and other polyolefines. Ethylene-vinyl ester copolymers can be made in for instance solution, suspension or emulsion processes. Said copolymers are predominantly made by emulsion techniques. Ethylene-vinyl ester copolymer processes must of necessity be operated under high pressure, since ethylene is a gas as well as a sluggish monomer.

A process for emulsion polymerisation of ethylene and at least one vinyl ester typically contains monomers, water, protective colloids and/or surfactants, initiators, buffers and maybe molecular weight regulators. Typically, only a portion of the monomers and catalysts are initially charged and the remainder is added during the course of the reaction.

Many different combinations of surfactants and/or protective colloids are used in said emulsion polymerisation. Ethylene-vinyl ester copolymer emulsions can be made with a surfactant alone or with a protective colloid alone, but the usual practice is to use a combination of the two.

The initiators used in ethylene-vinyl ester polymerisations are the familiar free-radical types, such as hydrogen peroxide, peroxysulfates, benzoyl peroxide, t-butyl hydroperoxide, lauryl peroxide and redox combinations. In redox combinations, reducing agents, such as sodium metabisulfite, sodium formaldehyde sulfoxylate and ascorbic acid, are among those commonly used along with transition metal salts, such as ferrous sulphate. Emulsion polymerisations are usually conducted with water soluble initiators.

Varying the conditions of polymerisation results in either straight chain or crosslinked polymer emulsions. The incorporation of functional monomers such as n-methylol acrylamide or acrylic acid into the polymer provides the ability to crosslink the product in the application either through heat, catalysis or by a curing agent.

Copolymerisations usually must be performed with a continuous monomer feed to obtain homogeneous copolymer compositions. A major drawback in such a continuous monomer feed is the ethylene charging time. A possibility to reduce the time to completion (TTC), that is the ethylene charging time, by increasing the charging rate of ethylene, without negatively affecting the properties of obtained final products, would be very welcome by producers of ethylene-vinyl ester copolymers. A reduced TTC implies a shorter production time and thus an increased production rate without investment in new and/or additional equipment. TTC is determined as the reaction time necessary to feed a predetermined amount of ethylene monomer at a constant pressure. A polymerisation with a higher ethylene monomer uptake rate at the same reactor pressure will thus have a lower TTC value and can consequently be completed in a shorter time.

Ethylene-vinyl ester copolymers, such as ethylene-vinyl acetate copolymers are used in for instance adhesives, coating, such as exterior and interior protective and decorative paints, and textiles, such as non-woven fabrics, which can be applied by most industrial techniques, such as brushing, knife coating, roller coating, spraying, or dipping. Ethylene-vinyl acetate copolymers containing for instance 21-30% by weight of vinyl acetate are widely used in hot-melt adhesives. The ethylene-vinyl acetate copolymers are then mixed with waxes, rubbers and resins to yield hot-melt adhesives.

Detailed information on copolymerisations of ethylene and vinyl esters are available in the scientific literature, such as Encyclopedia of Polymer Science, Vol. 6, 1967, Copolymerzation of Ethylene with Polar Comonomers, pp. 388-431 and Houben-Weyl Methoden der Organischen Chemie, Band XIV Makromolekulare Stoffe Teil 1, 1961, Polymerisation des Vinylacetates und höherer Vinylester, pp. 905-918.

The present invention provides quite unexpectedly a pressure polymerisation process for obtaining a copolymer comprising ethylene and vinyl ester units, wherein the charging time of ethylene can be substantially reduced, such as halved, compared to known prior art processes. The pressure polymerisation of the present invention is a substantially customary process characterised in that it is significantly improved by being performed in the presence of at least one dendritic polymer, such as a dendritic polyester, polyether, polyesteramide and/or polyetheramide. Said dendritic polymer is during said polymerisation preferably present in an amount of 0.1-20%, such as 0.1-10% or 0.5-5%.

Said dendritic polymer is advantageously and preferably a dendritic polyester, polyether, polyesteramide or polyetheramide built up from alcohols, epoxies, oxetanes, aminoalcohols, hydroxyfunctional carboxylic acids, carboxylic acids or anhydrides, glycidyl esters and/or glycidyl ethers. It is of course understood that alcohols, epoxies, oxetanes, aminoalcohols, hydroxyfunctional carboxylic acids, carboxylic acids or anhydrides, glycidyl esters and/or glycidyl ethers include mono, di, tri and polyfunctional compounds possessing necessary amount of reactive groups, sites and/or functions to yield and/or participate in the formation of dendritic structures, including dendrimers. Said dendritic polymer may furthermore be at least partly further chain extended by addition of for instance at least one linear or branched chain extender and/or chain stopper, such as at least one alkylene oxide, at least one saturated or unsaturated aliphatic or aromatic carboxylic acid or at least one corresponding anhydride or halide, and/or at least one carboxyfunctional ester, polyester, ether and/or polyether. Said preferred dendritic polymers are substantially of the type disclosed in the published International Patent Applications WO 93/17060, WO 93/18075, WO 96/07688, WO 96/12754, WO 00/56802 and WO 01/16213 and WO 02/040572, which all are included herein as disclosure of preferred dendritic polymers. Preferred embodiments of said dendritic polymer include dendritic polyesters and polyethers having a hydroxyfunctionality, such as having six or more hydroxyl groups. The hydroxyfunctionality such a dendritic polymer may be derived from one or more hydroxyl, hydroxyalkyl, hydroxyalkoxy, hydroxyalkoxyalkyl and/or hydroxyalkylamide groups and/or the like.

Said at least one vinyl ester is in preferred embodiments of the present invention a vinyl ester of at least one linear or branched carboxylic acid having for instance 1-12 carbon atoms. Especially preferred embodiments include vinyl esters such as vinyl acetate, vinyl propionate, vinyl isobutyrate, vinyl 2-ethylhexanoate, vinyl versatate and vinyl laurate. The most preferred vinyl esters are vinyl acetate and vinyl versatate.

Said yielded copolymer may optionally in various embodiments additionally comprise monomer units derived from at least one crosslinking functional monomer, such as at least one bi-functional monomer having at least one polymerisable vinyl group and at least one hydroxyalkyl group or a monomer being an ether of such a compound. Said at least one crosslinking monomer can suitably be for instance an unsaturated organic acid amide, such as acryl amide, a N-methylol derivative of an unsaturated organic acid amide, such as N-methylolacrylamide and/or N-methylolmethacrylamide, or an ether of a N-methylol derivative, such as N-(iso-butoxymethyl)acrylamide and/or N-(n-butoxymethyl)acrylamide. Further suitable crosslinking monomers include glycidyl acrylates, glycidyl methacrylates, multifunctional acrylates and multifunctional methacrylates, allylmethacrylate, alkoxyvinylsilanes, alkoxyacrylsilanes and/or alkoxymethacrylsilanes. Said at least one crosslinking monomer is typically present in an amount of for instance 0-10%, such as 0.1-10%, 0.3-8%, 0.3-6%, 0.4-2%, 0.5-2% or 1-6%, depending on for instance desired properties, crosslinking density and selected crosslinking monomer.

Multifunctional acrylates and methacrylates are to be understood as di, tri and polyesters of di, tri or polyhydric alcohols and acrylic and/or methacrylic acid and can suitably be exemplified by diacrylates and dimethacrylates, such as butanediol diacrylate, dipropylene glycol diacrylate, hexandiol diacrylate, tripropylene glycol diacrylate, butanediol dimethacrylate, ethylene glycol dimethacrylate and diethylene glycol dimethacrylate, and/or exemplified by 2-hydroxyalkyl-2-alkyl-1,3-propanediol acrylates, 2,2-dihydroxyalkyl-1,3-propanediol acrylates, 2-hydroxyalkoxy-2-alkyl-1,3-propanediol acrylates, 2,2-dihydroxyalkoxy-1,3-propanediol acrylates, 2-hydroxyalkoxyalkyl-2-alkyl-1,3-propanediol acrylates and/or 2,2-dihydroxyalkoxyalkyl-1,3-propanediol acrylates, such as trimethylolpropane triacrylate, ethoxylated trimethylolpropane triacrylate and ethoxylated pentaerythritol diacrylate.

Said silanes include compounds such as trialkoxyvinylsilanes, alkyldialkoxyvinylsilanes, acryloxyalkoxysilanes, acryloxyalkylalkoxysilanes, alkoxyacrylsilanes, methacryloxy-alkoxysilanes, methacryloxyalkylalkoxysilane and/or alkoxymethacrylsilanes, wherein said alkyl and/or alkoxy is for instance linear or branched having for instance 1-4 carbon atoms. Said silanes can suitably be exemplified by trimethoxyvinylsilane, triethoxyvinylsilane, triisopropoxyvinylsilane, propyldiisopropoxyvinylsilane, methoxymethacrylsilane and/or 3-methacryloxypropyltriisopropoxysilane.

Said yielded copolymer may, furthermore, optionally in said embodiments additionally comprise monomer units derived from at least one stabilising functional monomer having at least one radically polymerisable group, such as a charged group selected from sulphate, sulphonate, phosphate and/or carboxylic acid, and/or at least one colloidally and/or sterically stabilising group, such as alkoxy having a chain length of 4-60 alkoxy units derived from for instance ethylene oxide. Said stabilising monomer is preferably acrylic acid, methacrylic acid and/or vinylsulphonates, such as sodium vinylsulphonate. Said stabilising monomer is suitably and preferably present in an amount of 0-5%, such as 0.01-5%, 0.05-2% or 0.5-1.5%.

Said yielded copolymer may, yet furthermore, optionally comprise additional monomer units derived from at least one monoester of acrylic, methacrylic, crotonic acid and/or isocrotonic acid. Preferred monoesters include C₁-C₁₀ alkyl acrylates and methacrylates, such as methyl acrylate, ethyl acrylate, butyl acrylate, 2-ethylhexyl acrylate, methyl methacrylate, ethyl methacrylate and/or butyl methacrylate. Said ester is suitably and preferably present in an amount in of 0-50%, such as 0.01-50%, 1-40% or 5-30%.

The pressure polymerisation process of the present invention is preferably performed at a weight ratio charged ethylene to charged vinyl ester of 1-60% ethylene and 99-40% vinyl ester, such as at a weight ratio ethylene to vinyl ester of 1:99%, 10:90%, 15:85%, 40:60%, 50:50% or 60:40%.

The pressure polymerisation process of the present invention is suitably an emulsion, a solution or a suspension polymerisation. Said polymerisation is most preferably an emulsion polymerisation performed at a pressure of 1-200 bar, such as 3-150 or 5-100 bar, and at a temperature of 0-100° C., such as 9-90° C. or 20-85° C.

A polymerisation process, wherein the polymerisation is performed in the presence of dendritic polymer can, furthermore, advantageously be used in the manufacture of for instance ethylene homopolymers and copolymers comprising monomer units derived from styrene and butadiene instead of disclosed ethylene and at least one vinyl ester. The suitable amount of dendritic polymer in an ethylene homopolymerisation and/or in a styrene-butadiene copolymersation is to be found within a range similar to above disclosed, but is preferably empirically determined.

Without further elaboration, it is believed that one skilled in the art can, using the preceding description, utilise the present invention to its fullest extent. While particular embodiments of the invention will be shown in below Examples, it will be understood, of course, that the invention is not limited thereto since many modifications may be made, and it is, therefore, contemplated to cover by the appended claims any such modifications as fall within the true spirit and scope of the invention. Copolymers comprising monomer units derived from ethylene and vinyl acetate will hereinafter be used as model compounds. In the following Examples 1-6 show:
Example 1: Manufacture, without the presence of a dendritic polymer, of a copolymer comprising ethylene and vinyl acetate units. The copolymer furthermore comprises 1.5 parts per hundred of a cross linking functional monomer and 0.1 parts per hundred of a stabilising functional monomer. Reference to the embodiment polymerisation presented in Example 2.
Example 2: Manufacture, in the presence of 0.5 parts per hundred of a dendritic polymer according to an embodiment of the present invention, of a copolymer comprising ethylene and vinyl acetate units. The copolymer furthermore comprises 1.5 parts per hundred of a cross linking functional monomer and 0.1 parts per hundred of a stabilising functional monomer.
Example 3: Manufacture, without the presence of a dendritic polymer, of a copolymer comprising ethylene and vinyl acetate units. The copolymer furthermore comprises 0.5 parts per hundred of a cross linking functional monomer and 0.1 parts per hundred of a stabilising functional monomer. Reference to the embodiment polymerisation presented in Example 4.
Example 4: Manufacture, in the presence of 0.5 parts per hundred of a dendritic polymer according to an embodiment of the present invention, of a copolymer comprising ethylene and vinyl acetate units. The copolymer furthermore comprises 0.5 parts per hundred of a cross linking functional monomer and 0.1 parts per hundred of a stabilising functional monomer.
Example 5: Manufacture, without the presence of a dendritic polymer, of a copolymer comprising ethylene and vinyl acetate units. The copolymer furthermore comprises 1.5 parts per hundred of a cross linking functional monomer. Reference to the polymerisation presented in Example 6.
Example 6: Manufacture, in the presence of 1.0 parts per hundred of a dendritic polymer according to an embodiment of the present invention, of a copolymer comprising ethylene and vinyl acetate units. The copolymer furthermore comprises 1.5 parts per hundred of a cross linking functional monomer.

The amount of dendritic polymer, crosslinking functional monomer (CMF) and stabilising functional monomer (SFM) used in Examples 1-6 as given in the text are summarised in Table 1. The time to completion (TTC) and the properties of obtained final dispersions are given in Table 2. The ethylene monomer uptake is presented as a function of reaction time in Graphs 1 and 2.

### EXAMPLE 1

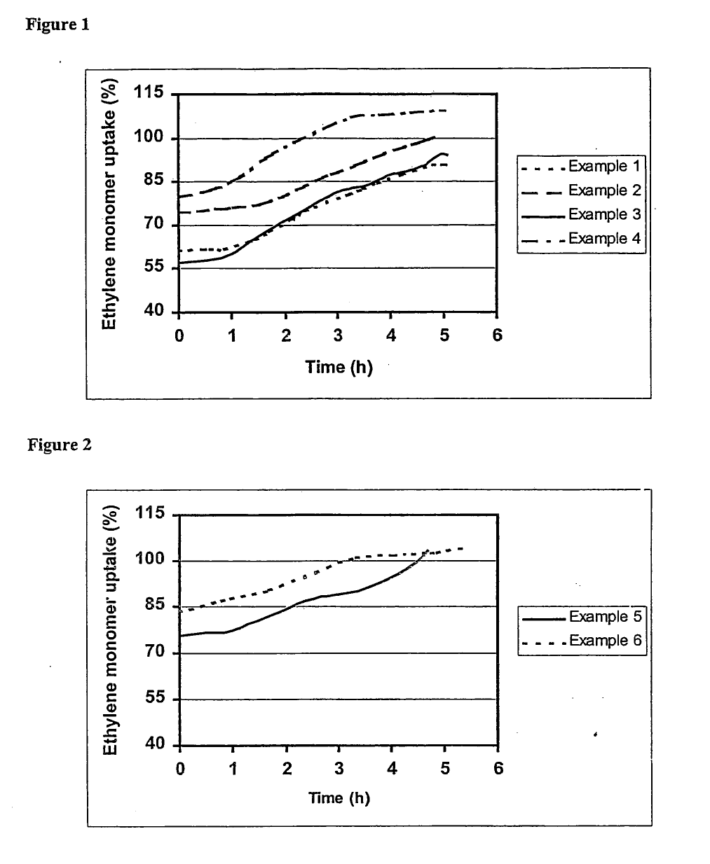

2.4 parts per hundred (pph) of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany), 4.4E-3 pph of a defoamer (Agitan® 305, Müntzing Chemie GmbH, Germany) and 33.3 pph of water were charged to a pressure reactor and the reactor was heated to a polymerisation temperature of 62° C. 3.4 pph of vinyl acetate and 0.6 pph of ethylene were now charged together with 0.02 pph of ammonium persulphate dissolved in 0.3 pph of water. Subsequent the so called pre-reaction, 35.6 pph of vinyl acetate was continuously fed during 5 hours together with a solution of 0.17 pph of ammonium persulphate dissolved in 2.8 pph of water. A reactor pressure of 55 bar was, when charging of vinyl acetate commenced, applied by charging the ethylene monomer to the reactor. Said pressure was maintained until 7.8 pph of ethylene was charged and the ethylene charging was then stopped. A solution of 1.5 pph of a crosslinking functional monomer (N-methylolacrylamide) and 0.1 pph of a stabilising functional monomer (sodium vinylsulphonate) dissolved in 11.4 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 1. The time to completion (TTC) and the properties of the final dispersion are given in Table 2.

### EXAMPLE 2

2.3 pph of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany), 4.4E-3 pph of a defoamer (Agitan® 305, Müntzing Chemie GmbH, Germany), 0.5 pph of a dendritic polyester (Boltorn® H20, Perstorp Specialty Chemicals AB, Sweden) and 33.1 pph of water were charged to a pressure reactor and the reactor was heated to a polymerisation temperature of 62° C. 3.4 pph of vinyl acetate and 0.6 pph of ethylene were now charged together with 0.02 pph of ammonium persulphate dissolved in 0.3 pph of water. Subsequent the so called pre-reaction, 35.4 pph of vinyl acetate was continuously fed during 5 hours together with a solution of 0.17 pph of ammonium persulphate dissolved in 2.8 pph of water. A reactor pressure of 55 bar was, when charging of vinyl acetate commenced, applied by charging the ethylene monomer to the reactor. Said pressure was maintained until 7.7 pph of ethylene was charged and the ethylene charging was then stopped. A solution of 1.5 pph of a crosslinking functional monomer (N-methylolacrylamide) and 0.1 pph of a stabilising functional monomer (sodium vinylsulphonate) dissolved in 11.4 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 1. The TTC and the properties of the final dispersion are given in Table 2.

### EXAMPLE 3

2.4 pph of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany), 4.5E-3 pph of a defoamer (Agitan® 305, Müntzing Chemie GmbH, Germany) and 34 pph of water were charged to a pressure reactor and the reactor was heated to a polymerisation temperature of 62° C. 3.5 pph of vinyl acetate and 0.6 pph of ethylene were now charged together with 0.02 pph of ammonium persulphate dissolved in 0.3 pph of water. Subsequent the so called pre-reaction, 36.4 pph of vinyl acetate was continuously fed during 5 hours together with a solution of 0.18 pph of ammonium persulphate dissolved in 2.8 pph of water. A reactor pressure of 55 bar was, when charging of vinyl acetate commenced, applied by charging the ethylene monomer to the reactor. Said pressure was maintained until 7.9 pph of ethylene was charged and the ethylene charging was then stopped. A solution of 0.5 pph of a crosslinking functional monomer (N-(iso-butoxymethyl)acrylamide) and 0.1 pph of a stabilising functional monomer (sodium vinylsulphonate) dissolved in 10.6 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 1. The TTC and the properties of the final dispersion are given in Table 2.

### EXAMPLE 4

2.4 pph of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany), 4.5E-3 pph of a defoamer (Agitan® 305, Müntzing Chemie GmbH, Germany), 0.5 pph of a dendritic polyester (Boltorn® H20, Perstorp Specialty Chemicals AB, Sweden) and 33.8 pph of water were charged to a pressure reactor and the reactor was heated to a polymerisation temperature of 62° C. 3.5 pph of vinyl acetate and 0.6 pph of ethylene were now charged together with 0.02 pph of ammonium persulphate dissolved in 0.3 pph of water. Subsequent the so called pre-reaction, 36.2 pph of vinyl acetate was continuously fed during 5 hours together with a solution of 0.18 pph of ammonium persulphate dissolved in 2.8 pph of water. A reactor pressure of 55 bar was, when charging of vinyl acetate commenced, applied by charging the ethylene monomer to the reactor. Said pressure was maintained until 7.9 pph of ethylene was charged and the ethylene charging was then stopped. A solution of 0.5 pph of a crosslinking functional monomer (N-(iso-butoxymethyl)acrylamide) and 0.1 pph of a stabilising functional monomer (sodium vinyl sulphonate) dissolved in 10.5 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 1. The TTC and the properties of the final dispersion are given in Table 2.

### EXAMPLE 5

2.4 pph of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany) and 33.5 pph of water were charged to a pressure reactor and the reactor was heated to a polymerisation temperature of 62° C. 3.5 pph of vinyl acetate and 0.6 pph of ethylene were now charged together with 0.02 pph of ammonium persulphate dissolved in 0.3 pph of water. Subsequent the so called pre-reaction, 35.8 pph of vinyl acetate was continuously fed during 5 hours together with a solution of 0.18 pph of ammonium persulphate dissolved in 2.8 pph of water. A reactor pressure of 55 bar was, when charging of vinyl acetate commenced, applied by charging the ethylene monomer to the reactor. Said pressure was maintained until 7.8 pph of ethylene was charged and the ethylene charging was then stopped. A solution of 1.5 pph of a crosslinking functional monomer (N-methylolacrylamide) dissolved in 11.1 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 2. The TTC and the properties of the final dispersion are given in Table 2.

### EXAMPLE 6

2.4 pph of a colloidal stabiliser (polyvinyl alcohol), 0.1 pph of sodium metabisulphite, 0.1 pph of sodium acetate, 0.4 pph of a nonionic surfactant (Emulsogen® EPN 287, Clariant GmbH, Functional Chemicals, Germany), 1.0 pph of a dendritic polyester (Boltorn® H20, Perstorp Specialty Chemicals AB, Sweden) and 33.2 pph of water were charged to a pressure reactor and the reactor was heated to a polymerisation temperature of 62° C. 3.4 pph of vinyl acetate and 0.6 pph of ethylene were now charged together with 0.02 pph of ammonium persulphate dissolved in 0.3 pph of water. Subsequent the so called pre-reaction, 35.5 pph of vinyl acetate was continuously fed during 5 hours together with a solution of 0.17 pph of ammonium persulphate dissolved in 2.8 pph of water. A reactor pressure of 55 bar was, when charging of vinyl acetate commenced, applied by charging the ethylene monomer to the reactor. Said pressure was maintained until 7.7 pph of ethylene was charged and the ethylene charging was then stopped. A solution of 1.5 pph of a crosslinking functional monomer (N-methylolacrylamide) dissolved in 11.0 pph of water were separately and continuously charged to the reactor during 4 hours, parallel to the other monomer feed. The reactor was, following the continuous charging of the monomer mixtures and the ammonium persulphate solution, kept at 62° C. for a further hour. The prepared dispersion was now allowed to cool to room temperature. The ethylene monomer uptake is presented as a function of reaction time in FIG. 2. The TTC and the properties of the final dispersion are given in Table 2.

TABLE 1
Summary of recipes of Examples 1-6.

| | Dendritic polymer | CFM | SFM |
|---|---|---|---|
| Example no. | pph | pph | pph |
| 1 | 0 | 1.5 | 0.1 |
| 2 | 0.5 | 1.5 | 0.1 |
| 3 | 0 | 0.5 | 0.1 |
| 4 | 0.5 | 0.5 | 0.1 |
| 5 | 0 | 1.5 | 0 |
| 6 | 1.0 | 1.5 | 0 |

CFM = Crosslinking functional monomer.
SFM = Stabilising functional monomer.

TABLE 2
Properties of dispersions obtained in Examples 1-6
and TTC for polymerisations in said Examples.

| | Solids content | | | Viscosity | | TTC |
|---|---|---|---|---|---|---|
| Example no. | % | Tg ° C. | pH | Pas | Grit % | hrs |
| 1 | 50 | 4 | 4.0 | 1.0 | 0.05 | 6.2 |
| 2 | 49 | 2 | 3.8 | 0.8 | 0.25 | 4.7 |
| 3 | 49 | 1 | 4.0 | 1.7 | 0.09 | 5.3 |
| 4 | 49 | 4 | 4.0 | 2.7 | 0.05 | 2.3 |
| 5 | 49 | 3 | 3.8 | 1.9 | 0.04 | 4.4 |
| 6 | 52 | 4 | 4.3 | 5.8 | 0.36 | 3.1 |

Tg = Glass transition temperature.

Table 2 shows, when Examples 1-6 are compared, that there are not any major differences in obtained properties. Times to completion (TTC) are, however, substantially reduced when a dendritic polymer is present during the polymerisation (Examples 2, 4 and 6). The reduced TTC;s are even more obvious when the ethylene monomer uptake during the polymerisation is plotted as a function of time (see enclosed FIGS. 1 and 2).

1. A pressure polymerisation process yielding a copolymer comprising monomer units derived from ethylene and at least one vinyl ester wherein said polymerisation is performed in presence of at least one dendritic polymer, such as a dendritic polyester, polyether, polyesteramide and/or polyetheramide.

2. A pressure polymerisation process according to claim 1, wherein said dendritic polymer is present in an amount of 0.1-20%.

3. A pressure polymerisation process according to claim 1, wherein said dendritic polymer is built up from a core molecule and at least one branching chain extender at a molar ratio yielding at least one dendritic generation.

4. A pressure polymerisation process according to claim 3, wherein said core molecule is a di, tri or polyfunctional alcohol and that said at least one branching chain extender is at least one di, tri or polyhydoxyfunctional monocarboxylic acid.

5. A pressure polymerisation process according to claim 3, wherein said core molecule is a di, tri or polyfunctional alcohol and that said at least one branching chain extender is at least one hydoxyfunctional oxetane of at least one tri or polyfunctional alcohol.

6. A pressure polymerisation process according to claim 3, wherein said dendritic polymer is at least partly further chain extended by addition of at least one linear or branched chain extender and/or chain stopper.

7. A pressure polymerisation process according to claim 6, wherein said at least one linear or branched chain extender and/or chain stopper is at least one alkylene oxide, at least one saturated or unsaturated aliphatic or aromatic carboxylic acid or at least one corresponding anhydride or halide, and/or at least one carboxyfunctional ester, polyester, ether and/or polyether.

8. A pressure polymerisation process according to claim 1, wherein said dendritic polymer has at least two dendritic generations.

9. A pressure polymerisation process according to claim 1, wherein said at least one vinyl ester is vinyl acetate, vinyl propionate, vinyl isobutyrate, vinyl 2-ethylhexanoate, vinyl versatate, and/or vinyl laurate.

10. A pressure polymerisation process according to claim 1, wherein said at least one vinyl ester is vinyl acetate, and/or vinyl versatate.

11. A pressure polymerization process according to claim 1, wherein said yielded copolymer additionally comprises monomer units derived from at least one cross linking functional monomer.

12. A pressure polymerisation process according to claim 11, wherein said at least one cross linking functional monomer is a monomer having at least one polymerisable vinyl group.

13. A pressure polymerisation process according to claim 11, wherein said at least one cross linking functional monomer is at least one unsaturated organic acid amide, at least one N-methylol derivative of at least one unsaturated organic acid amide and/or at least one ether of at least one N-methylol derivative of at least one unsaturated organic acid amide.

14. A pressure polymerisation process according to claim 11, wherein said at least one cross linking functional monomer is acryl amide, N-methylolacrylamide, N-methylolmethacrylamide, N-(iso-butoxymethyl)-acrylamide and/or N-(n-butoxymethyl)acrylamide.

15. A pressure polymerisation process according to claim 11, wherein said at least one cross linking functional monomer is a glycidyl acrylate, a glycidyl methacrylate, and/or allyl methacrylate.

16. A pressure polymerisation process according to claim 11, wherein said at least one cross linking functional monomer is at least one di, tri and multifunctional ester of a di, tri or polyhydric alcohol and acrylic and/or methacrylic acid.

17. A pressure polymerisation process according to claim 16, wherein said at least one cross linking functional monomer is butanediol diacrylate, dipropylene glycol diacrylate, hexandiol diacrylate, tripropylene glycol diacrylate, butanediol dimethacrylate, ethylene glycol dimethacrylate, diethylene glycol dimethacrylate, trimethylolpropane triacrylate, trimethylolpropane triacrylate, ethoxylated trimethylolpropane triacrylate, and/or ethoxylated pentaerythritol diacrylate.

18. A pressure polymerisation process according to claim 11, wherein said at least one cross linking functional monomer is at least one trialkoxyvinylsilane, alkyldialkoxyvinylsilane, acryloxyalkoxysilane, acryloxyalkylalkoxysilane, alkoxyacrylsilane, methacryloxyalkoxysilane, methacryloxyalkylalkoxysilane, and/or alkoxymethacrylsilane.

19. A pressure polymerisation process according to claim 18, wherein said alkyl and/or said alkoxy is linear or branched having 1-4 carbon atoms.

20. A pressure polymerisation process according to claim 18, wherein said at least one cross linking monomer is trimethoxyvinylsilane, triethoxyvinylsilane, triisopropoxyvinylsilane, methoxymethacrylsilane, and/or 3-methacryloxypropyltriisopropoxysilane.

21. A pressure polymerisation process according to claim 11, wherein said at least one cross linking functional monomer is present in an amount of 0.1-10%.

22. A pressure polymerisation process according to claim 1, wherein said yielded copolymer additionally comprises monomer units derived from at least one stabilising functional monomer having at least one radically polymerisable group and/or at least one colloidally and/or sterically stabilising group.

23. A pressure polymerisation process according to claim 22, wherein said at least one stabilising functional monomer is vinylsulphonate and/or sodium vinylsulphonate.

24. A pressure polymerisation process according to claim 22, wherein said at least one stabilising functional monomer is acrylic and/or methacrylic acid.

25. A pressure polymerisation process according to claim 22, wherein said at least one stabilising functional monomer is present in an amount of 0.01-5%.

26. A pressure polymerisation process according to claim 1, wherein said yielded copolymer additionally comprises monomer units derived from at least one monoester of acrylic, methacrylic, crotonic acid, and/or isocrotonic acid.

27. A pressure polymerisation process according to claim 26, wherein said at least one monoester is a C₁-C₁₀ alkyl acrylate or methacrylate, such as methyl acrylate, ethyl acrylate, butyl acrylate, 2-ethylhexyl acrylate, methyl methacrylate, ethyl methacrylate, and/or butyl methacrylate.

28. A pressure polymerisation process according to claim 26, wherein said at least one monoester is present in an amount of 0.1-50%.

29. A pressure polymerisation process according to claim 1, wherein a weight ratio of charged ethylene to charged vinyl ester of 1-60% ethylene and 99-40% vinyl ester is employed.

30. A pressure polymerisation process according to claim 1, wherein said polymerisation is performed at a pressure of 1-200 bar.

31. A pressure polymerisation process according to claim 1, wherein said polymerisation is performed at a temperature of 0-100° C.

32. A pressure polymerisation process according to claim 1, wherein said polymerisation is an emulsion, a solution, or a suspension polymerisation.

33. A pressure polymerisation process according to claim 1, wherein said yielded copolymer comprises monomer units derived from ethylene and vinyl acetate and that said copolymer is obtained by emulsion polymerisation.
